(19) United States
(12) Patent Application Publication
(10) Pub. No.: US 2024/0121639 A1
(43) Pub. Date: Apr. 11, 2024

(54) PHASE NOISE POWER LEVEL SIGNALING

(71) Applicant: QUALCOMM Incorporated, San Diego, CA (US)

(72) Inventors: Aviv REGEV, Tel Aviv (IL); Ronen SHAKED, Kfar Saba (IL)

(21) Appl. No.: 17/936,509

(22) Filed: Sep. 29, 2022

(51) Int. Cl. H04W 24/08

(52) U.S. Cl. CPC H04W 24/08

(57) ABSTRACT

Various aspects of the present disclosure generally relate to wireless communication. In some aspects, a user equipment (UE) may receive, from a network node, an indication of a phase noise power level associated with the network node. The UE may receive, from the network node, a communication without applying phase noise correction associated with the communication based at least in part on the phase noise power level and one or more conditions being satisfied. Numerous other aspects are provided.

### FIELD OF THE DISCLOSURE

Aspects of the present disclosure generally relate to wireless communication and specifically, to techniques and apparatuses for phase noise power level signaling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

For communications using high frequency carriers, phase noise may be an impairment to the communications that limits throughput of a communication channel. Reference signals, such as phase tracking reference signals (PTRSs), may be used to enable a user equipment (UE) to estimate the phase noise and a residual frequency offset and to correct based on the estimate. The UE may correct for the phase noise and the residual frequency offset based at least in part on receiving the PTRSs. Phase noise, if not corrected, may be a multiplicative process (for example, a compounding process) in the time domain that results in cyclic convolution of a downlink channel with corresponding phase noise taps in the frequency domain. Uncorrected phase noise may lead to common phase error (CPE) and/or inter-cell interference (ICI) related error and/or a noise floor that may limit communication efficiencies based at least in part on an integrated phase noise (IPN).

Phase noise correction operations may consume significant power resources and/or may introduce latency into communications between a UE and a network node (for example, associated with an amount of time that is used to perform the phase noise mitigation or cancellation operations). Additionally, in some cases, phase noise correction operations may be unnecessary, such as where the phase noise is negligible as compared to current channel conditions and/or where a phase noise level is low enough to enable a UE to successfully decode a signal. Communicating and/or measuring PTRSs may be unnecessary when, for example, a UE can decode an associated downlink transmission without using the PTRSs to estimate and/or correct phase noise. By allocating resources for PTRSs, a UE and/or a network node may consume power resources, processing resources, communication resources, and/or network resources that may be used to improve other aspects of communications, such as throughput. Additionally or alternatively, by allocating resources for PTRSs (for example, with a pilot size that is oversized), a UE and/or a network node may consume resources that may be used to improve other aspects of communications such as throughput. However, a UE may be unaware of when phase noise correction operations may be unnecessary because the UE may be unable to differentiate between phase noise caused by a transmitter (for example, a network node) and other sources of phase noise within a signal (for example, thermal noise). Therefore, the UE may unnecessarily consume power resources and/or introduce latency associated with performing phase noise correction operations that do not meaningfully improve a reception or decoding performance of a signal.

### SUMMARY

Some aspects described herein relate to a user equipment (UE) for wireless communication. The UE may include at least one memory and at least one processor communicatively coupled with the at least one memory. The at least one processor may be configured to cause the UE to receive, from a network node, an indication of a phase noise power level associated with the network node. The at least one processor may be configured to cause the UE to receive, from the network node, a communication without applying phase noise correction associated with the communication based at least in part on the phase noise power level and one or more conditions being satisfied.

Some aspects described herein relate to a network node for wireless communication. The network node may include at least one memory and at least one processor communicatively coupled with the at least one memory. The at least one processor may be configured to cause the network node to obtain a phase noise power level associated with the network node. The at least one processor may be configured to cause the network node to transmit an indication, for a UE, of the phase noise power level associated with the network node.

Some aspects described herein relate to a method of wireless communication performed by a UE. The method may include receiving, from a network node, an indication of a phase noise power level associated with the network node. The method may include receiving, from the network node, a communication without applying phase noise correction associated with the communication based at least in part on the phase noise power level and one or more conditions being satisfied.

Some aspects described herein relate to a method of wireless communication performed by a network node. The method may include obtaining a phase noise power level associated with the network node. The method may include transmitting an indication, for a UE, of the phase noise power level associated with the network node.

Some aspects described herein relate to a non-transitory computer-readable medium that stores a set of instructions for wireless communication by a UE. The set of instructions, when executed by one or more processors of the UE, may cause the UE to receive, from a network node, an indication of a phase noise power level associated with the network node. The set of instructions, when executed by one or more processors of the UE, may cause the UE to receive, from the network node, a communication without applying phase noise correction associated with the communication based at least in part on the phase noise power level and one or more conditions being satisfied.

Some aspects described herein relate to a non-transitory computer-readable medium that stores a set of instructions for wireless communication by a network node. The set of instructions, when executed by one or more processors of the network node, may cause the network node to obtain a phase noise power level associated with the network node. The set of instructions, when executed by one or more processors of the network node, may cause the network node to transmit an indication, for a UE, of the phase noise power level associated with the network node.

Some aspects described herein relate to an apparatus for wireless communication. The apparatus may include means for receiving, from a network node, an indication of a phase noise power level associated with the network node. The apparatus may include means for receiving, from the network node, a communication without applying phase noise correction associated with the communication based at least in part on the phase noise power level and one or more conditions being satisfied.

Some aspects described herein relate to an apparatus for wireless communication. The apparatus may include means for obtaining a phase noise power level associated with the apparatus. The apparatus may include means for transmitting an indication, for a UE, of the phase noise power level associated with the network node.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example phase tracking reference signal (PTRS) structure in a physical downlink shared channel (PDSCH), in accordance with the present disclosure.

FIG. 5 is a diagram of an example associated with phase noise power level signaling, in accordance with the present disclosure.

FIG. 6 is a flowchart illustrating an example process performed, for example, by a UE, that supports phase noise power level signaling in accordance with the present disclosure.

FIG. 7 is a flowchart illustrating an example process performed, for example, by a network node, that supports phase noise power level signaling in accordance with the present disclosure.

FIG. 8 is a diagram of an example apparatus for wireless communication that supports phase noise power level signaling in accordance with the present disclosure.

FIG. 9 is a diagram of an example apparatus for wireless communication that supports phase noise power level signaling in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to phase noise power level signaling. Some aspects more specifically relate to a network node transmitting, and a user equipment (UE) receiving, an indication of a phase noise power level associated with the network node. The phase noise power level may be an integrated phase noise (IPN) associated with a power spectrum density of a transmitter of the network node (for example, indicating a transmitting phase noise introduced due to radio frequency (RF) components of the network node). In some aspects, the UE may receive, from the network node, a communication without applying phase noise correction associated with the communication based at least in part on the phase noise power level and one or more conditions being satisfied. In other words, the signaling of the phase noise power level of the network node may enable the UE to refrain from performing phase noise correction if the one or more conditions are satisfied.

For example, the one or more conditions may include a condition associated with a difference between a channel thermal noise level and the phase noise power level satisfying a threshold. As another example, the one or more conditions may include a condition associated with an error vector magnitude (EVM) value associated with a channel via which the communication is received satisfying a threshold. As another example, the one or more conditions may include a condition associated with a total noise level of the channel satisfying a threshold.

Particular aspects of the subject matter described in this disclosure can be implemented to realize one or more of the following potential advantages. In some examples, the described techniques can be used to enable the UE to identify when performing phase noise correction can be skipped (for example, based at least in part on the phase noise power level of the network node and the one or more conditions described herein). As a result, the UE may conserve power and computing resources that would have otherwise been used performing an unnecessary phase noise correction operation. Further, refraining from performing the phase noise correction may reduce latency that would have otherwise been introduced associated with the UE performing an unnecessary phase noise correction operation. In some aspects, refraining from performing the phase noise correction may conserve network resources and/or radio resources that would have been otherwise used associated with the communication of pilot signals (for example, phase tracking reference signals (PTRSs) or other signals) that are associated with performing an unnecessary phase noise correction operation.

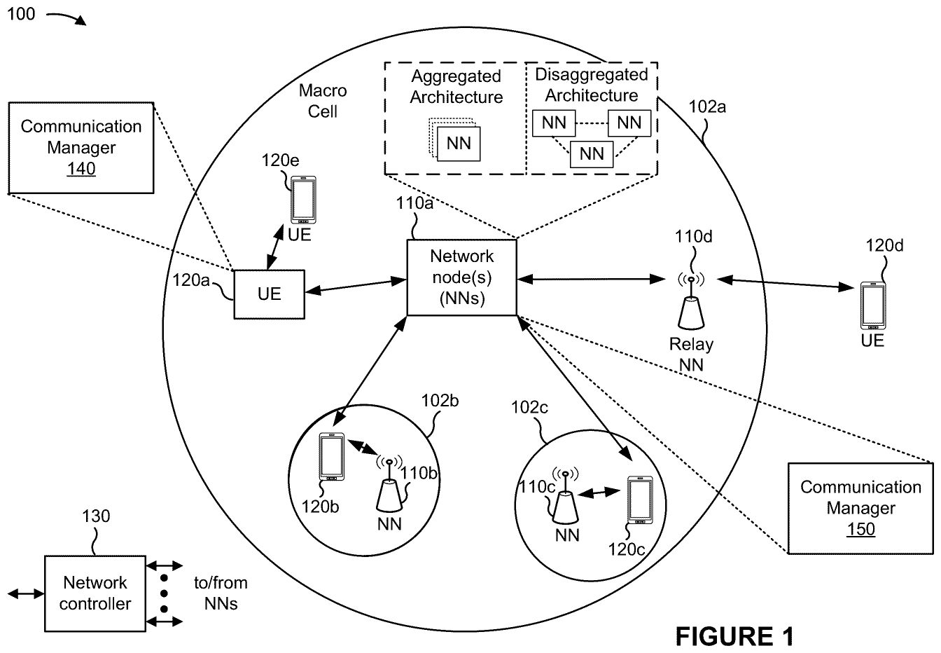

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a network node, an indication of a phase noise power level associated with the network node; and receive, from the network node, a communication without applying phase noise correction associated with the communication based at least in part on the phase noise power level and one or more conditions being satisfied. Additionally or alternatively, the communication manager 140 may perform one or more other operations described herein.

In some aspects, the network node 110 may include a communication manager 150. As described in more detail elsewhere herein, the communication manager 150 may obtain a phase noise power level associated with the network node; and transmit an indication, for a UE, of the phase noise power level associated with the network node. Additionally or alternatively, the communication manager 150 may perform one or more other operations described herein.

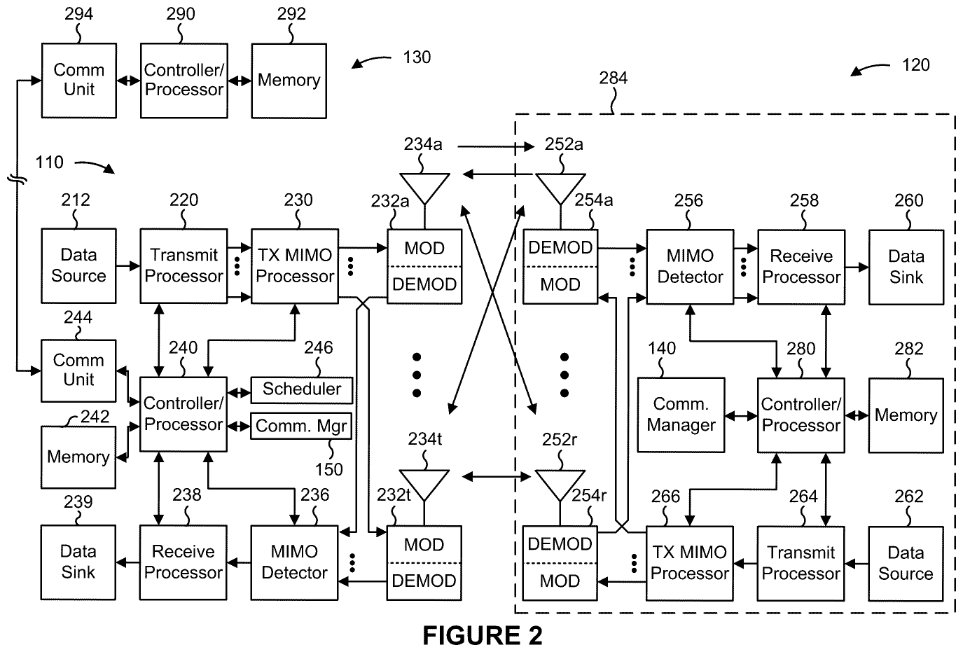

FIG. 2 is a diagram illustrating an example network node in communication with a user equipment (UE) in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

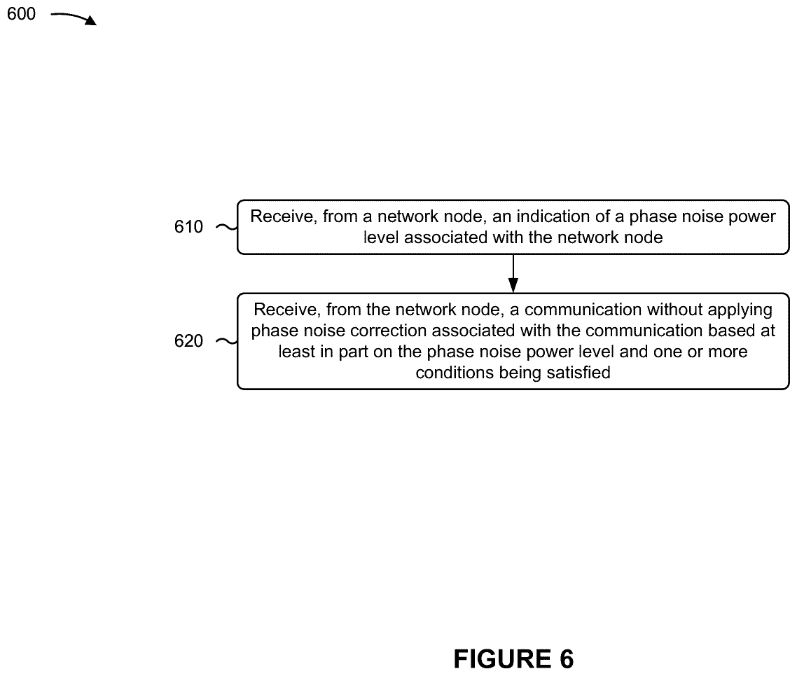

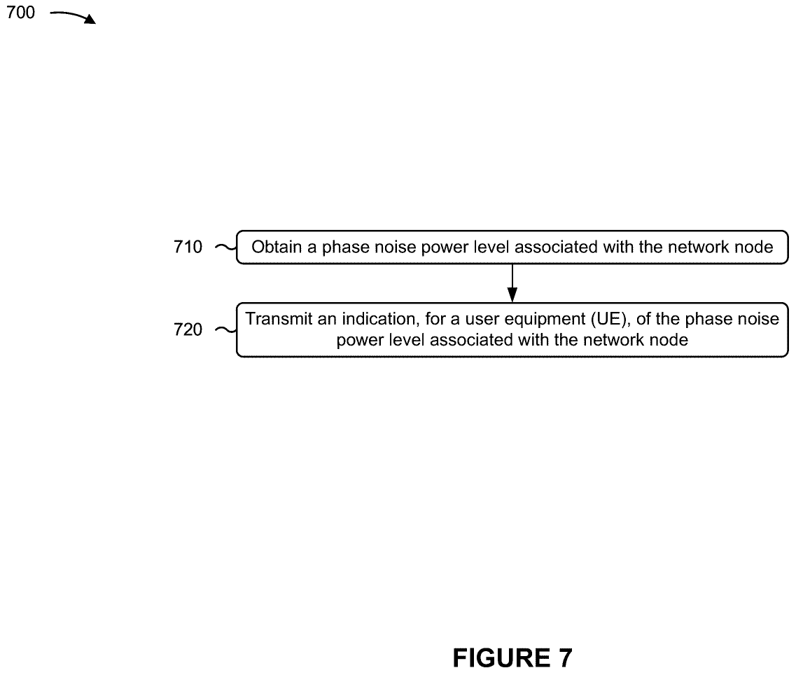

The controller/processor 240 of the network node 110, the controller/processor 280 of the UE 120, or any other component(s) of FIG. 2 may perform one or more techniques associated with phase noise power level signaling, as described in more detail elsewhere herein. For example, the controller/processor 240 of the network node 110, the controller/processor 280 of the UE 120, or any other component(s) of FIG. 2 may perform or direct operations of, for example, process 600 of FIG. 6, process 700 of FIG. 7, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 600 of FIG. 6, process 700 of FIG. 7, or other processes as described herein. In some examples, executing instructions may include running the instructions, converting the instructions, compiling the instructions, or interpreting the instructions, among other examples.

In some aspects, the UE 120 includes means for receiving, from a network node, an indication of a phase noise power level associated with the network node; and/or means for receiving, from the network node, a communication without applying phase noise correction associated with the communication based at least in part on the phase noise power level and one or more conditions being satisfied. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for obtaining a phase noise power level associated with the network node; and/or means for transmitting an indication, for a UE, of the phase noise power level associated with the network node. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

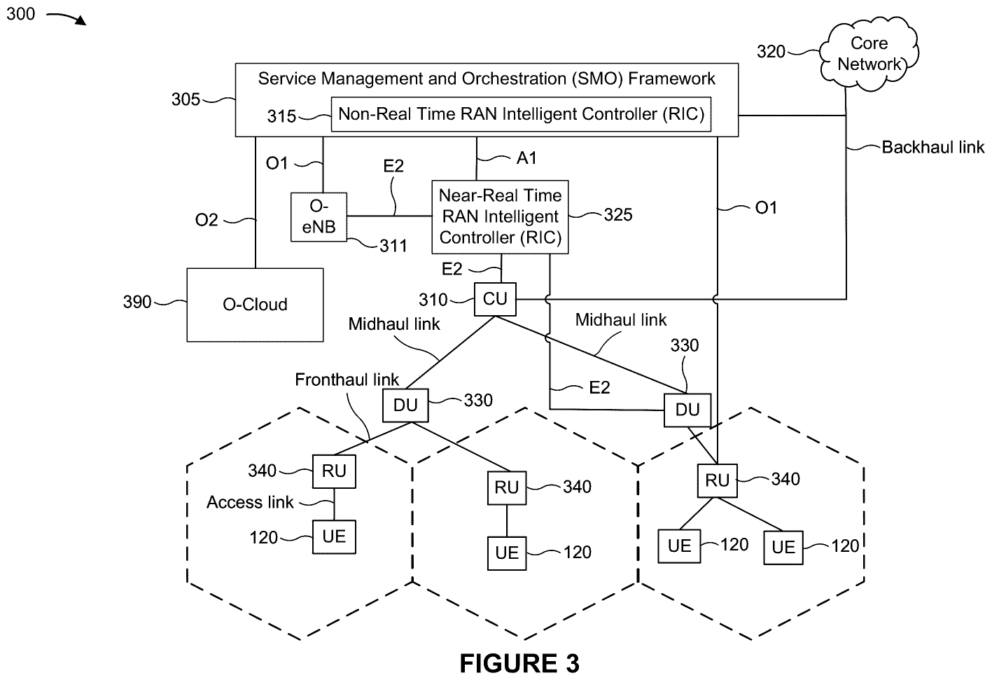

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

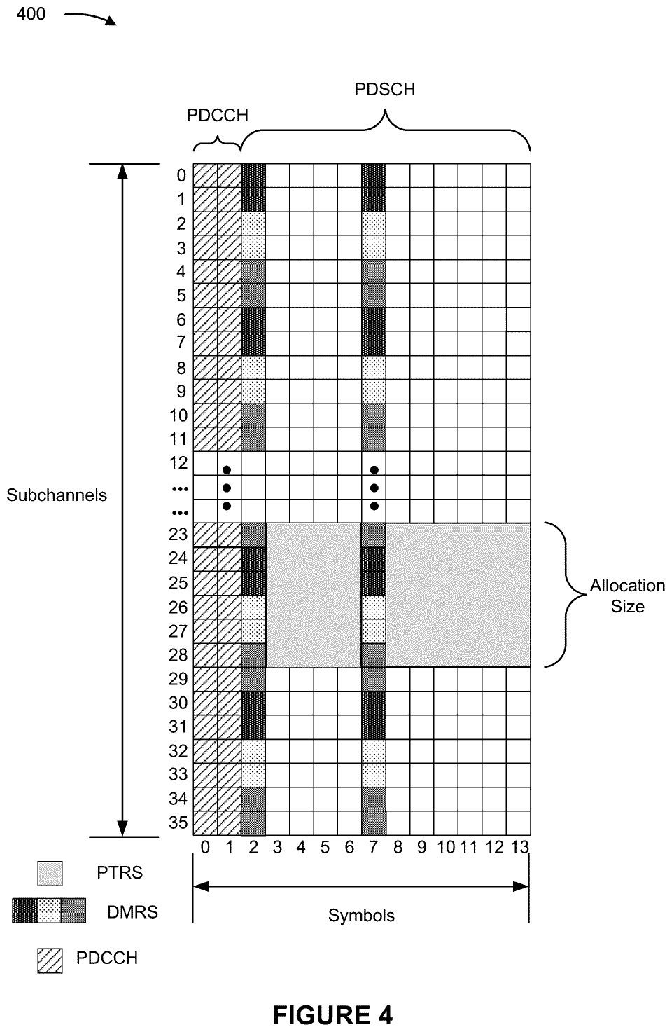

FIG. 4 is a diagram illustrating an example phase tracking reference signal (PTRS) structure 400 in a physical downlink shared channel (PDSCH), in accordance with the present disclosure. As shown, the PDSCH may include a quantity of subchannels (for example, 36 subchannels) and a quantity of symbols (for example, 14 symbols).

Although the PTRS structure 400 describes PTRSs, any type of pilots for phase noise mitigation may be used instead of PTRSs. For example, enhanced PTRSs (ePTRSs) may be used to carry both PTRS sequences along with data. In other words, a PDSCH, or a physical uplink shared channel (PUSCH), may be transmitted having data (for example, application data, streaming data, and/or data communicated with an application server, among other examples) multiplexed with a PTRS sequence in resources allocated for PTRSs.

A network node 110 may transmit, and a UE 120 may receive (for example, or attempt to receive), PTRSs, DMRSs, and/or data, using the PDSCH. Although described with reference to a PDSCH, the structure may be similarly applied to a PUSCH.

The PTRSs may be a pilot for the PDSCH and may have a density in a frequency domain (for example, relative to subcarriers) and a time domain (for example, relative to symbols allocated for data). As shown in FIG. 4, the PTRSs may be frequency-domain contiguous pilots. An allocation size of the PTRSs indicates a quantity of contiguous subchannels allocated to the PTRSs. For example, as shown in FIG. 4, the PTRSs may be described as having an allocation size of 6 subchannels spanning from subchannel 23 through subchannel 28.

In some examples, the PTRSs may be allocated using 1 resource (for example, a set of subchannels) per 2 resource blocks or 1 resource per 4 resource blocks, among other examples. A configuration of the PTRSs may be configured (for example, using RRC signaling) and/or may be based at least in part on an associated modulation and coding scheme (MCS) of the PDSCH. The PTRSs may be defined by a Gold sequence that is known to a receiving device such that the receiving device can compare received signaling to the Gold sequence to determine phase noise and/or inter-cell interference (ICI).

As shown, the PDSCH may have a quantity (for example, 2) of single-symbol DMRSs of a DMRS type (for example, DMRS type 2 as defined, or otherwise fixed, by a wireless communication standard, such as the 3GPP). In some examples, the PDSCH may have 1 DMRS symbol per resource block. A receiving device may use the DMRS to roughly estimate and/or correct a frequency-based error within the symbol that includes the DMRS.

A PDSCH or a PUSCH may include PTRSs for a receiving device (for example, a UE and/or a network node, among other examples) to account for residual frequency offset (for example, a frequency offset that is developed within a resource block or slot), phase noise (for example, introduced by an oscillator at a transmitting device and/or the receiving device, among other examples), and/or a common phase error (for example, a common phase rotation of subcarriers of the PDSCH and/or the PUSCH, among other examples), among other examples. For example, a receiving device may use the PTRSs to estimate and/or correct phase noise (for example, based at least in part on a detected residual frequency offset and/or a common phase error (CPE), among other examples).

For communications using high frequency carrier waves (for example, FR2 or above), phase noise may be an impairment to the communications that limits throughput of a communication channel. PTRSs may be used to enable a receiving device to estimate the phase noise and a residual frequency offset and to correct based at least in part on the estimate. A receiving device may correct for the phase noise and the residual frequency offset based at least in part on receiving the PTRSs. Phase noise, if not corrected, may be a multiplicative process (for example, a compounding process) in the time domain that results in cyclic convolution of a PDSCH with corresponding phase noise taps in the frequency domain. Uncorrected phase noise may lead to CPE and ICI related error and/or a noise floor that may limit communication efficiencies based at least in part on an integrated phase noise (IPN).

Phase noise correction operations may consume significant power resources and/or may introduce latency into communications between a UE and a network node (for example, associated with an amount of time that is used to perform the phase noise mitigation or cancellation operations). Additionally, in some cases, phase noise correction operations may be unnecessary, such as where the phase noise is negligible as compared to current channel conditions and/or where a phase noise level is low enough to enable a receiving device to demodulate a signal. Using PTRSs may be unnecessary when, for example, a receiving device can decode an associated uplink transmission or downlink transmission without using the PTRSs to estimate and/or correct phase noise. By allocating resources for PTRSs, a UE and/or a network node may consume power resources, computing, communication, and/or network resources that may be used to improve other aspects of communications such as throughput. Additionally or alternatively, by allocating too many resources for PTRSs (for example, with a pilot size that is oversized), a UE and/or a network node may consume computing, communication, and/or network resources that may be used to improve other aspects of communications such as throughput. However, a UE may be unaware of when phase noise correction operations may be unnecessary because the UE may be unable to differentiate between phase noise caused by a transmitter and other sources of phase noise within a signal (for example, thermal noise). Therefore, the UE may unnecessarily consume power resources and/or introduce latency associated with performing phase noise correction operations that do not meaningfully improve a reception or demodulation performance of a signal.

Various aspects relate generally to phase noise power level signaling. Some aspects more specifically relate to a network node transmitting, and a UE receive, an indication of a phase noise power level associated with the network node. The phase noise power level may indicate an IPN associated with a power spectrum density of a transmitter of the network node (for example, indicating a transmitting phase noise introduced due to RF components of the network node). In some aspects, the UE may receive, from the network node, a communication without applying phase noise correction associated with the communication based at least in part on the phase noise power level and one or more conditions being satisfied. In other words, the signaling of the phase noise power level of the network node may enable the UE to refrain from performing phase noise correction if the one or more conditions are satisfied.

For example, the one or more conditions may include a condition associated with a difference between a channel thermal noise level and the phase noise power level satisfying a threshold. As another example, the one or more conditions may include a condition associated with an error vector magnitude (EVM) value associated with a channel via which the communication is received satisfying a threshold. As another example, the one or more conditions may include a condition associated with a total noise level of the channel satisfying a threshold.

Particular aspects of the subject matter described in this disclosure can be implemented to realize one or more of the following potential advantages. In some examples, the described techniques can be used to enable the UE to identify when performing phase noise correction can be skipped (for example, based at least in part on the phase noise power level of the network node and the one or more conditions described herein). As a result, the UE may conserve power resources that would have otherwise been used performing an unnecessary phase noise correction operation. Further, this may reduce latency that would have otherwise been introduced associated with the UE performing an unnecessary phase noise correction operation. Additionally, this may conserve network resources and/or radio resources that would have been otherwise used associated with the communication of pilot signals (for example, PTRSs or other signals) that are associated with performing an unnecessary phase noise correction operation.

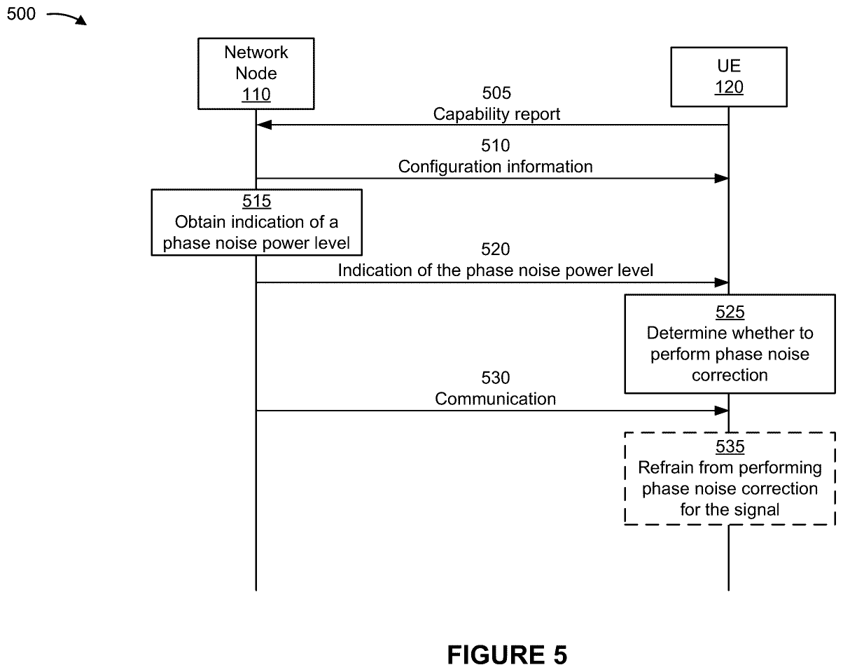

FIG. 5 is a diagram of an example associated with phase noise power level signaling 500, in accordance with the present disclosure. As shown in FIG. 5, a network node 110 (for example, a CU, a DU, and/or an RU) may communicate with a UE 120. In some aspects, the network node 110 and the UE 120 may be part of a wireless network (for example, the wireless network 100). The UE 120 and the network node 110 may have established a wireless connection prior to operations shown in FIG. 5.

In some aspects, actions described herein as being performed by the network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

In a first operation 505, the UE 120 may transmit, and the network node 110 may receive, a capability report. In some aspects, the capability report may indicate UE support for selectively performing phase noise correction based at least in part on a signaled phase noise power level associated with the network node and one or more conditions being satisfied. For example, the capability report may indicate that the UE 120 supports skipping (for example, refraining from performing) a phase noise correction operation (for example, a phase noise mitigation or cancellation operation) based at least in part on the signaled phase noise power level and one or more conditions being satisfied.

In a second operation 510, the network node 110 may transmit, and the UE 120 may receive, configuration information. In some aspects, the UE 120 may receive the configuration information via one or more of RRC signaling, one or more MAC control elements (MAC-CEs), and/or downlink control information (DCI), among other examples. In some aspects, the configuration information may include an indication of one or more configuration parameters (for example, already stored by the UE 120 and/or previously indicated by the network node 110 or other network device) for selection by the UE 120, and/or explicit configuration information for the UE 120 to use to configure itself, among other examples.

In some aspects, the configuration information may indicate that the UE 120 is to receive an indication of a phase noise power level associated with the network node 110. As used herein, “phase noise power level” may be a phase noise level that is associated with transmissions by the network node 110. For example, the phase noise power level associated with the network node 110 may be a phase noise level (for example, in units of decibels (dBs)) that results from transmissions by the network node 110 (for example, due to an oscillator or other RF hardware components of the network node 110). The configuration information may indicate that the network node 110 is to transmit, and the UE 120 is to receive, an indication of the phase noise power level associated with the network node 110. In some aspects, the configuration information may indicate the phase noise power level associated with the network node 110.

In some aspects, the configuration information may indicate that the UE 120 may skip (for example, refrain from performing) a phase noise correction operation (for example, a phase noise mitigation or cancellation operation) based at least in part on one or more conditions being satisfied. The one or more conditions may be based at least in part on the signaled phase noise power level associated with the network node 110 and one or more channel conditions (for example, associated with a channel between the UE 120 and the network node 110). For example, the one or more conditions may include a condition associated with a difference between a channel thermal noise level and the phase noise power level satisfying a threshold. For example, a condition may be associated with an estimated channel thermal noise being greater than the signaled phase noise power level by a threshold amount. Thermal noise (sometimes referred to as Nyquist noise or Johnson noise) may be electronic noise generated in an electrical conductor by the thermal agitation of electrons. Thermal noise may be a function of the ambient temperature of the conductor and bandwidth of the frequency. Thermal noise may be introduced due to operations of one or more components of the UE 120. For example, if the thermal noise is dominant as compared to the phase noise power level introduced by transmission at the network node 110, then performing a phase noise correction operation may have a minimal effect on improving a performance of communications (for example, may have no, or a small, improvement of an error vector magnitude (EVM) of the channel) between the UE 120 and the network node 110. Therefore, in such scenarios, the UE 120 may refrain from performing the phase noise correction operation to conserve power and reduce latency.

As another example, the configuration information may indicate that a condition is associated with an EVM value of the channel satisfying a threshold. An EVM may reflect circuit distortion at a transmitter (for example, at the network node 110). An EVM measurement may be the normalized ratio of the difference between a measured signal and an ideal or reference signal. The difference may be referred to as the error vector. The EVM may be a metric that characterizes phase coherence across bands over time. For example, a transmitting device, such as the network node 110, may transmit a signal. A receiving device, such as the UE 120 and may remove a cyclic prefix (CP) from the signal, perform a fast Fourier transform (FFT). The receiving device may perform pre-FFT or post-FFT time/frequency synchronization and symbol detection/decoding. The EVM measurement may be defined over one slot in the time domain t and over N_{BW}^{RB} subcarriers in the frequency domain f such that:

$$EVM = \sqrt{\frac{{\sum }_{t ∈ T} {\sum }_{f ∈ F ( t )} {\vert {Z}^{′} ( t , f ) - I ( t , f ) \vert}^{2}}{{\sum }_{t ∈ T} {\sum }_{f ∈ F ( t )} {\vert I ( t , f ) \vert}^{2}}}$$

where T is the set of symbols with the considered modulation scheme being active within the slot, F(t) is the set of subcarriers within the N_{BW}^{RB} subcarriers with the considered modulation scheme being active in symbol t, I(t,f) is the ideal signal reconstructed by the measurement equipment in accordance with relevant transmission models, and Z′(t,f) is a specified modified signal under test. The modified signal Z′(t,f) may compensate for time, frequency, amplitude, and/or phase impairments. The EVM may be evaluated by the UE 120 using a modulated signal in a physical downlink shared channel (PDSCH). For example, if an EVM value measured by the UE 120 before performing phase noise correction indicates that the UE 120 will be able to sufficiently decode a signal (for example, for a given MCS being used by the UE 120), then performing a phase noise correction operation may have a minimal, or small, effect on improving a performance of communications between the UE 120 and the network node 110. Therefore, in such scenarios, the UE 120 may refrain from performing the phase noise correction operation to conserve power and reduce latency.

In some aspects, the configuration information may indicate one or more thresholds associated with the one or more conditions. For example, the configuration information may indicate a value of a threshold to be used by the UE 120 to compare a difference between an estimated channel thermal noise level and the phase noise power level associated with the network node 110. As another example, the configuration information may indicate a value of a threshold to be used by the UE 120 when evaluating the EVM value of the channel.

The UE 120 may configure itself based at least in part on the configuration information. In some aspects, the UE 120 may be configured to perform one or more operations described herein based at least in part on the configuration information.

In a third operation 515, the network node 110 may obtain an indication of a phase noise power level associated with the network node 110. For example, the network node 110 may obtain the indication of the phase noise power level from a memory of the network node 110. In some aspects, the indication of the phase noise power level may be indicated in an original equipment manufacturer (OEM) configuration of the network node 110. For example, the phase noise power level of the network node 110 may be measured offline (for example, in a factory setting) and may be configured in a memory of the network node 110. For example, the phase noise power level may be based at least in part on a power spectrum density (for example, a phase noise power spectrum density) of signals transmitted by the network node 110. The phase noise power level may be an IPN that is based at least in part on the power spectrum density. The IPN may be measured or determined via a spectrum analyzer in an offline setting (for example, in a factory setting) and may be configured in a memory of the network node 110.

In a fourth operation 520, the network node 110 may transmit, and the UE 120 may receive, an indication of the phase noise power level associated with the network node 110. In some aspects, the network node 110 may transmit the indication of the phase noise power level via the configuration information (for example, the fourth operation 520 may be part of, or included in, the second operation 510). In other aspects, the network node 110 may transmit the indication of the phase noise power level via a separate communication from the configuration information.

The network node 110 may transmit, and the UE 120 may receive, the indication of the phase noise power level via a downlink communication. In some aspects, the network node 110 may transmit, and the UE 120 may receive, the indication of the phase noise power level via RRC signaling (for example, in an RRC communication). As another example, the network node 110 may transmit, and the UE 120 may receive, the indication of the phase noise power level via MAC signaling (for example, in one or more MAC-CE communications). As another example, the network node 110 may transmit, and the UE 120 may receive, the indication of the phase noise power level via PHY layer signaling (for example, via a PHY layer communication, a physical downlink control channel (PDCCH) communication, a PDSCH communication, or a DCI communication). As another example, the network node 110 may transmit, and the UE 120 may receive, the indication of the phase noise power level via system information signaling (for example, in a system information block (SIB)).

In some aspects, the network node 110 may transmit, and the UE 120 may receive, the indication of the phase noise power level based at least in part on establishing an RRC connection. For example, the indication of the phase noise power level may be indicated as part of an RRC connection establishment procedure. In some aspects, the network node 110 may transmit, and the UE 120 may receive, the indication of the phase noise power level based at least in part on channel conditions. For example, the network node 110 may transmit, and the UE 120 may receive, the indication of the phase noise power level based at least in part on a channel parameter satisfying a threshold. The channel parameter may include a signal-to-noise ratio (SNR), a signal-to-interference-plus-noise ratio (SINR), an RSRP, an RSRQ, and/or a CQI, among other examples. As another example, the network node 110 may transmit, and the UE 120 may receive, the indication of the phase noise power level based at least in part on an MCS used for communications between the UE 120 and the network node 110. For example, the network node 110 may transmit, and the UE 120 may receive, the indication of the phase noise power level if the UE 120 and the network node 110 are using a first one or more MCSs. The network node 110 may not transmit the indication of the phase noise power level if the UE 120 and the network node 110 are using a second one or more MCSs.

In a fifth operation 525, the UE 120 may determine whether to perform phase noise correction. For example, the UE 120 may determine whether to perform phase noise correction based at least in part on the phase noise power level associated with the network node 110 and one or more conditions. The one or more conditions may be based at least in part on an SNR of the channel, a measured EVM of the channel (for example, measured before performing phase noise correction), an estimated channel thermal noise, and/or an MCS used by the UE 120, among other examples. In some aspects, the UE 120 may periodically determine whether to perform phase noise correction (for example, may periodically check whether the one or more conditions are satisfied). Additionally or alternatively, the UE 120 may determine whether to perform phase noise correction based at least in part on detecting that a communication is to be transmitted to the UE 120 (for example, based at least in part on receiving DCI scheduling the communication or determining that a periodic or semi-persistent communication is upcoming).

For example, the UE 120 may estimate a channel thermal noise level. For example, the UE 120 may estimate the channel thermal noise level based at least in part on measuring a channel noise level associated with the channel (for example, a total channel noise level). The UE 120 may obtain the channel thermal noise level based at least in part on a difference between the channel noise level and the phase noise power level associated with the network node 110. As another example, the UE 120 may estimate the channel thermal noise level based at least in part on measuring the channel thermal noise level via radio resources (for example, resource blocks or tones) associated with a downlink reference signal that are not allocated for data transmissions. For example, by measuring noise associated radio resources that are not allocated for data, the UE 120 may obtain an estimation of the thermal noise.

The one or more conditions may include a condition associated with a difference between the channel thermal noise level and the phase noise power level satisfying a thermal noise threshold. For example, if the difference between the channel thermal noise level and the phase noise power level satisfying the thermal noise threshold, then the condition may be satisfied. If the difference between the channel thermal noise level and the phase noise power level does not satisfy the thermal noise threshold, then the condition may not be satisfied. If the condition is satisfied, then the UE 120 may determine that the phase noise correction operation is not to be performed (for example, is to be skipped). In some aspects, if the condition is not satisfied, then the UE 120 may determine that the phase noise correction operation is to be performed by the UE 120. For example, if the channel thermal noise level is greater than the phase noise power level associated with the network node 110 (for example, by a threshold amount), then the phase noise may not be the dominant impairment on the channel (for example, the phase noise power level may be below a channel thermal noise floor level). Therefore, a phase noise estimation and correction operation may not improve an EVM of the channel (or may only slightly improve the EVM of the channel). Therefore, the UE 120 may refrain from performing the phase noise correction to conserve power and reduce latency.

As another example, the one or more conditions may include a condition associated with an EVM value of the channel satisfying an EVM threshold. For example, the UE 120 may measure an EVM value associated with the channel (for example, using a signal transmitted by the network node 110, as described in more detail elsewhere herein). In some aspects, the UE 120 may measure the EVM value without (or before) performing phase noise correction. If the EVM value satisfies the EVM threshold, then the condition may be satisfied. If the EVM value does not satisfy the EVM threshold, then the condition may not be satisfied. In some aspects, the EVM threshold may be based at least in part on an MCS used by the UE 120 and the network node 110 (for example, for one or more communications). For example, the configuration information may indicate a set of MCSs and respective EVM thresholds for the set of MCSs. The UE 120 may identify an EVM threshold that is associated with the MCS currently being used by the UE 120 and the network node 110. For example, for a given MCS, a given EVM value may indicate that a signal has sufficient quality to be successfully decoded by the UE 120. Therefore, if the measured EVM value of the channel (for example, before performing phase noise correction) is sufficient for decoding at the UE 120 for the current MCS, then the UE 120 may refrain from performing the phase noise correction to conserve power and reduce latency. In other words, the EVM value of the channel may indicate that signals transmitted via the channel have a sufficient quality to be decoded by the UE 120 even before performing the phase noise correction. Therefore, the UE 120 may refrain from performing the phase noise correction.

As another example, the one or more conditions include a condition associated with a total noise level of the channel satisfying a noise threshold. In some aspects, the EVM value of the channel may indicate, or be associated with the total noise level of the channel. The UE 120 may measure or estimate estimating a total noise level associated with the channel. If the total noise level satisfies the noise threshold, then the condition may be satisfied. If the total noise level value does not satisfy the noise threshold, then the condition may not be satisfied. The noise threshold may be based at least in part on an MCS being used by the UE 120, in a similar manner as described above in connection with the EVM threshold(s). For example, for a given MCS, if a total noise level of the channel is less than or equal to a given level, the UE 120 may be capable of successfully decoding a signal transmitted via the channel. Therefore, if the estimated total noise level of the channel satisfies the noise threshold (for example, indicating the given noise level acceptable for decoding when a given MCS is used), then the UE 120 may refrain from performing the phase noise correction to conserve power and reduce latency.

In some aspects, the UE 120 may determine that phase noise correction is not to be performed based on any one of the one or more conditions being satisfied. In other aspects, the UE 120 may determine that phase noise correction is not to be performed based on all of the one or more conditions being satisfied. In some aspects, the UE 120 may determine that phase noise correction is not to be performed based on a combination of the one or more conditions being satisfied.

In a sixth operation 530, the network node 110 may transmit, and the UE 120 may receive, a communication. For example, the communication may be transmitted via the channel between the UE 120 and the network node 110. The communication may be a downlink communication. In a seventh operation 535, the UE 120 may refrain from performing applying phase noise correction associated with the communication based at least in part on the phase noise power level and the one or more conditions being satisfied. For example, in the sixth operation 530, the UE 120 may receive the communication without applying phase noise correction associated with the communication based at least in part on the phase noise power level and the one or more conditions being satisfied. The UE 120 may perform the seventh operation 535 based at least in part on determining that phase noise correction is not to be performed (for example, as described in connection with the fifth operation 525). In other aspects, the UE 120, in the sixth operation 530, the UE 120 may receive the communication with applying phase noise correction associated with the communication based at least in part on the phase noise power level and the one or more conditions not being satisfied. For example, the UE 120 may not perform the seventh operation 535 based at least in part on determining that phase noise correction is to be performed (for example, as described in connection with the fifth operation 525).

As a result, the UE 120 may be enabled to identify when performing phase noise correction can be skipped (for example, based at least in part on the phase noise power level of the network node and the one or more conditions described herein). As a result, the UE 120 may conserve power resources that would have otherwise been used performing an unnecessary phase noise correction operation. Further, not performing the phase noise correction may reduce latency that would have otherwise been introduced associated with the UE performing an unnecessary phase noise correction operation. In some aspects, not performing the phase noise correction may conserve network resources and/or radio resources that would have been otherwise used associated with the communication of pilot signals (for example, PTRSs or other signals) that are associated with performing an unnecessary phase noise correction operation.

FIG. 6 is a flowchart illustrating an example process 600 performed, for example, by a UE, that supports phase noise power level signaling in accordance with the present disclosure. Example process 600 is an example where the UE (for example, UE 120) performs operations associated with phase noise power level signaling.

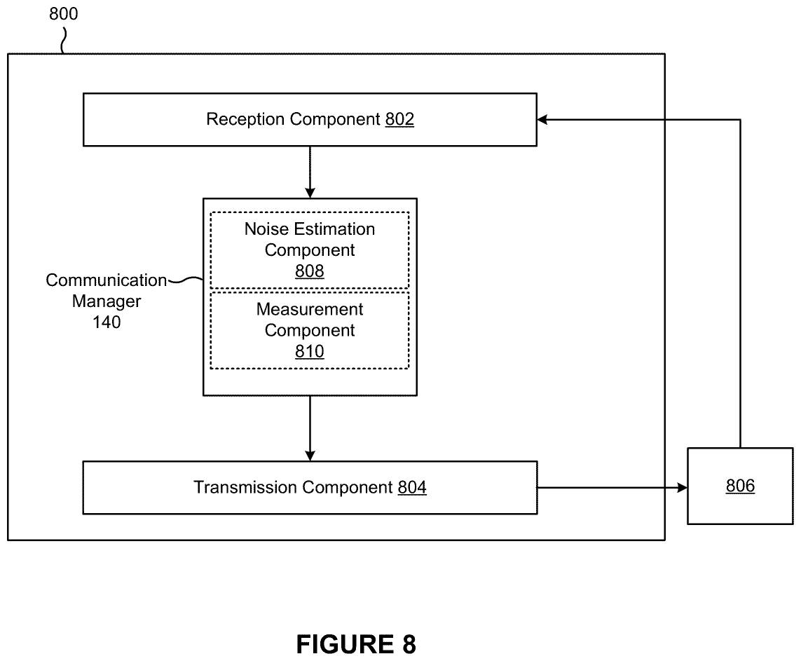

As shown in FIG. 6, in some aspects, process 600 may include receiving, from a network node, an indication of a phase noise power level associated with the network node (block 610). For example, the UE (such as by using communication manager 140 or reception component 802, depicted in FIG. 8) may receive, from a network node, an indication of a phase noise power level associated with the network node, as described above.

As further shown in FIG. 6, in some aspects, process 600 may include receiving, from the network node, a communication without applying phase noise correction associated with the communication based at least in part on the phase noise power level and one or more conditions being satisfied (block 620). For example, the UE (such as by using communication manager 140 or reception component 802, depicted in FIG. 8) may receive, from the network node, a communication without applying phase noise correction associated with the communication based at least in part on the phase noise power level and one or more conditions being satisfied, as described above.

Process 600 may include additional aspects, such as any single aspect or any combination of aspects described below or in connection with one or more other processes described elsewhere herein.

In a first additional aspect, receiving the indication of the phase noise power level comprises receiving the indication via a radio resource control communication or a MAC control element communication.

In a second additional aspect, alone or in combination with the first aspect, receiving the indication of the phase noise power level comprises receiving the indication via a physical layer communication.

In a third additional aspect, alone or in combination with one or more of the first and second aspects, the phase noise power level associated with the network node is an integrated phase noise power level associated with the network node.

In a fourth additional aspect, alone or in combination with one or more of the first through third aspects, process 600 includes estimating a channel thermal noise level, and wherein the one or more conditions include a condition associated with a difference between the channel thermal noise level and the phase noise power level satisfying a threshold.

In a fifth additional aspect, alone or in combination with one or more of the first through fourth aspects, estimating the channel thermal noise level comprises measuring a channel noise level associated with a channel via which the communication is received, and obtaining the channel thermal noise level based at least in part on a difference between the channel noise level and the phase noise power level.

In a sixth additional aspect, alone or in combination with one or more of the first through fifth aspects, estimating the channel thermal noise level comprises measuring the channel thermal noise level via radio resources associated with a downlink reference signal that are not allocated for data transmissions.

In a seventh additional aspect, alone or in combination with one or more of the first through sixth aspects, process 600 includes measuring an EVM value associated with a channel via which the communication is received, wherein the one or more conditions include a condition associated with the EVM value satisfying a threshold.

In an eighth additional aspect, alone or in combination with one or more of the first through seventh aspects, the threshold is based at least in part on a modulation and coding scheme associated with the communication.

In a ninth additional aspect, alone or in combination with one or more of the first through eighth aspects, process 600 includes estimating a total noise level associated with a channel via which the communication is received, wherein the one or more conditions include a condition associated with the total noise level satisfying a threshold.

In a tenth additional aspect, alone or in combination with one or more of the first through ninth aspects, the threshold is based at least in part on a modulation and coding scheme associated with the communication.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, by a network node, that supports phase noise power level signaling in accordance with the present disclosure. Example process 700 is an example where the network node (for example, network node 110) performs operations associated with phase noise power level signaling.

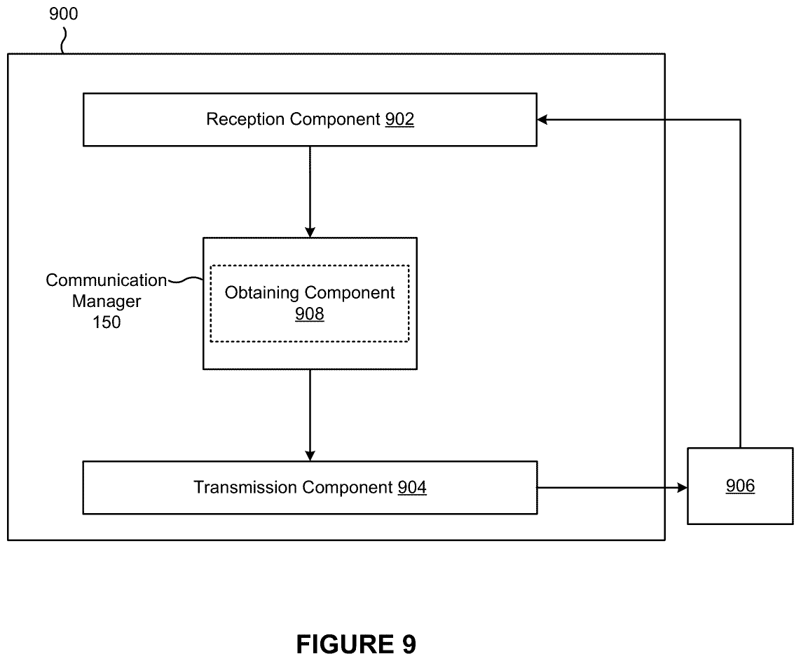

As shown in FIG. 7, in some aspects, process 700 may include obtaining a phase noise power level associated with the network node (block 710). For example, the network node (such as by using communication manager 150 or obtaining component 908, depicted in FIG. 9) may obtain a phase noise power level associated with the network node, as described above.

As further shown in FIG. 7, in some aspects, process 700 may include transmitting an indication, for a UE, of the phase noise power level associated with the network node (block 720). For example, the network node (such as by using communication manager 150 or transmission component 904, depicted in FIG. 9) may transmit an indication, for a UE, of the phase noise power level associated with the network node, as described above.

Process 700 may include additional aspects, such as any single aspect or any combination of aspects described below or in connection with one or more other processes described elsewhere herein.

In a first additional aspect, the indication of the phase noise power level enables a phase noise correction operation to be skipped for a channel associated with the UE.

In a second additional aspect, alone or in combination with the first aspect, transmitting the indication of the phase noise power level comprises transmitting the indication via a radio resource control communication or a MAC control element communication.

In a third additional aspect, alone or in combination with one or more of the first and second aspects, transmitting the indication of the phase noise power level comprises transmitting the indication via a physical layer communication.

In a fourth additional aspect, alone or in combination with one or more of the first through third aspects, the phase noise power level associated with the network node is an integrated phase noise power level associated with the network node.

In a fifth additional aspect, alone or in combination with one or more of the first through fourth aspects, obtaining the phase noise power level comprises obtaining the phase noise power level from a memory associated with the network node.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports phase noise power level signaling in accordance with the present disclosure. The apparatus 800 may be a UE, or a UE may include the apparatus 800. In some aspects, the apparatus 800 includes a reception component 802, a transmission component 804, and a communication manager 140, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to perform one or more operations described herein in connection with FIG. 5. Additionally or alternatively, the apparatus 800 may be configured to perform one or more processes described herein, such as process 600 of FIG. 6. In some aspects, the apparatus 800 may include one or more components of the UE described above in connection with FIG. 2.

The reception component 802 may receive communications, such as reference signals, control information, and/or data communications, from the apparatus 806. The reception component 802 may provide received communications to one or more other components of the apparatus 800, such as the communication manager 140. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, a modem, a demodulator, a MIMO detector, a receive processor, a controller/processor, and/or a memory of the UE described above in connection with FIG. 2.

The transmission component 804 may transmit communications, such as reference signals, control information, and/or data communications, to the apparatus 806. In some aspects, the communication manager 140 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, and/or a memory of the UE described above in connection with FIG. 2. In some aspects, the transmission component 804 may be co-located with the reception component 802 in a transceiver.

The communication manager 140 may receive or may cause the reception component 802 to receive, from a network node, an indication of a phase noise power level associated with the network node. The communication manager 140 may receive or may cause the reception component 802 to receive, from the network node, a communication without applying phase noise correction associated with the communication based at least in part on the phase noise power level and one or more conditions being satisfied. In some aspects, the communication manager 140 may perform one or more operations described elsewhere herein as being performed by one or more components of the communication manager 140.

The communication manager 140 may include a controller/processor, a memory, of the UE described above in connection with FIG. 2. In some aspects, the communication manager 140 includes a set of components, such as a noise estimation component 808, and/or a measurement component 810. Alternatively, the set of components may be separate and distinct from the communication manager 140. In some aspects, one or more components of the set of components may include or may be implemented within a controller/processor, a memory, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive, from a network node, an indication of a phase noise power level associated with the network node. The reception component 802 may receive, from the network node, a communication without applying phase noise correction associated with the communication based at least in part on the phase noise power level and one or more conditions being satisfied.

The noise estimation component 808 may estimate a channel thermal noise level.

The measurement component 810 may measure an EVM value associated with a channel via which the communication is received wherein the one or more conditions include a condition associated with the EVM value satisfying a threshold.

The noise estimation component 808 may estimate a total noise level associated with a channel via which the communication is received wherein the one or more conditions include a condition associated with the total noise level satisfying a threshold.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication that supports phase noise power level signaling in accordance with the present disclosure. The apparatus 900 may be a network node, or a network node may include the apparatus 900. In some aspects, the apparatus 900 includes a reception component 902, a transmission component 904, and a communication manager 150, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to perform one or more operations described herein in connection with FIG. 5. Additionally or alternatively, the apparatus 900 may be configured to perform one or more processes described herein, such as process 700 of FIG. 7. In some aspects, the apparatus 900 may include one or more components of the network node described above in connection with FIG. 2.

The reception component 902 may receive communications, such as reference signals, control information, and/or data communications, from the apparatus 906. The reception component 902 may provide received communications to one or more other components of the apparatus 900, such as the communication manager 150. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, a modem, a demodulator, a MIMO detector, a receive processor, a controller/processor, and/or a memory of the network node described above in connection with FIG. 2.

The transmission component 904 may transmit communications, such as reference signals, control information, and/or data communications, to the apparatus 906. In some aspects, the communication manager 150 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, and/or a memory of the network node described above in connection with FIG. 2. In some aspects, the transmission component 904 may be co-located with the reception component 902 in a transceiver.

The communication manager 150 may obtain a phase noise power level associated with the network node. The communication manager 150 may transmit or may cause the transmission component 904 to transmit an indication, for a user equipment (UE), of the phase noise power level associated with the network node. In some aspects, the communication manager 150 may perform one or more operations described elsewhere herein as being performed by one or more components of the communication manager 150.

The communication manager 150 may include a controller/processor, a memory, a scheduler, and/or a communication unit of the network node described above in connection with FIG. 2. In some aspects, the communication manager 150 includes a set of components, such as an obtaining component 908, among other examples. Alternatively, the set of components may be separate and distinct from the communication manager 150. In some aspects, one or more components of the set of components may include or may be implemented within a controller/processor, a memory, a scheduler, and/or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The obtaining component 908 may obtain a phase noise power level associated with the network node. The transmission component 904 may transmit an indication, for a UE, of the phase noise power level associated with the network node.

The transmission component 904 may transmit an indication of one or more conditions associated with performing phase noise correction.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving, from a network node, an indication of a phase noise power level associated with the network node; and receiving, from the network node, a communication without applying phase noise correction associated with the communication based at least in part on the phase noise power level and one or more conditions being satisfied.

Aspect 2: The method of Aspect 1, wherein receiving the indication of the phase noise power level comprises receiving the indication via a radio resource control communication or a medium access control (MAC) control element communication.

Aspect 3: The method of Aspect 1, wherein receiving the indication of the phase noise power level comprises receiving the indication via a physical layer communication.

Aspect 4: The method of any of Aspects 1-3, wherein the phase noise power level associated with the network node is an integrated phase noise power level associated with the network node.

Aspect 5: The method of any of Aspects 1-4, further comprising: estimating a channel thermal noise level, and wherein the one or more conditions include a condition associated with a difference between the channel thermal noise level and the phase noise power level satisfying a threshold.

Aspect 6: The method of Aspect 5, wherein estimating the channel thermal noise level comprises: measuring a channel noise level associated with a channel via which the communication is received; and obtaining the channel thermal noise level based at least in part on a difference between the channel noise level and the phase noise power level.

Aspect 7: The method of any of Aspects 5-6, wherein estimating the channel thermal noise level comprises: measuring the channel thermal noise level via radio resources associated with a downlink reference signal that are not allocated for data transmissions.

Aspect 8: The method of any of Aspects 1-7, further comprising: measuring an error vector magnitude (EVM) value associated with a channel via which the communication is received, wherein the one or more conditions include a condition associated with the EVM value satisfying a threshold.

Aspect 9: The method of Aspect 8, wherein the threshold is based at least in part on a modulation and coding scheme associated with the communication.

Aspect 10: The method of any of Aspects 1-9, further comprising: estimating a total noise level associated with a channel via which the communication is received, wherein the one or more conditions include a condition associated with the total noise level satisfying a threshold.

Aspect 11: The method of Aspect 10, wherein the threshold is based at least in part on a modulation and coding scheme associated with the communication.

Aspect 12: A method of wireless communication performed by a network node, comprising: obtaining a phase noise power level associated with the network node; and transmitting an indication, for a user equipment (UE), of the phase noise power level associated with the network node.

Aspect 13: The method of Aspect 12, wherein the indication of the phase noise power level enables a phase noise correction operation to be skipped for a channel associated with the UE.

Aspect 14: The method of any of Aspects 12-13, wherein transmitting the indication of the phase noise power level comprises transmitting the indication via a radio resource control communication or a medium access control (MAC) control element communication.

Aspect 15: The method of any of Aspects 12-13, wherein transmitting the indication of the phase noise power level comprises transmitting the indication via a physical layer communication.

Aspect 16: The method of any of Aspects 12-15, wherein the phase noise power level associated with the network node is an integrated phase noise power level associated with the network node.

Aspect 17: The method of any of Aspects 12-16, wherein obtaining the phase noise power level comprises obtaining the phase noise power level from a memory associated with the network node.

Aspect 18: An apparatus for wireless communication at a device, comprising a processor; memory coupled with the processor; and instructions stored in the memory and executable by the processor to cause the apparatus to perform the method of one or more of Aspects 1-11.

Aspect 19: A device for wireless communication, comprising a memory and one or more processors coupled to the memory, the one or more processors configured to perform the method of one or more of Aspects 1-11.

Aspect 20: An apparatus for wireless communication, comprising at least one means for performing the method of one or more of Aspects 1-11.

Aspect 21: A non-transitory computer-readable medium storing code for wireless communication, the code comprising instructions executable by a processor to perform the method of one or more of Aspects 1-11.

Aspect 22: A non-transitory computer-readable medium storing a set of instructions for wireless communication, the set of instructions comprising one or more instructions that, when executed by one or more processors of a device, cause the device to perform the method of one or more of Aspects 1-11.

Aspect 23: An apparatus for wireless communication at a device, comprising a processor; memory coupled with the processor; and instructions stored in the memory and executable by the processor to cause the apparatus to perform the method of one or more of Aspects 12-17.

Aspect 24: A device for wireless communication, comprising a memory and one or more processors coupled to the memory, the one or more processors configured to perform the method of one or more of Aspects 12-17.

Aspect 25: An apparatus for wireless communication, comprising at least one means for performing the method of one or more of Aspects 12-17.

Aspect 26: A non-transitory computer-readable medium storing code for wireless communication, the code comprising instructions executable by a processor to perform the method of one or more of Aspects 12-17.

Aspect 27: A non-transitory computer-readable medium storing a set of instructions for wireless communication, the set of instructions comprising one or more instructions that, when executed by one or more processors of a device, cause the device to perform the method of one or more of Aspects 12-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one memory; and
at least one processor communicatively coupled with the at least one memory, the at least one processor configured to cause the UE to:
receive, from a network node, an indication of a phase noise power level associated with the network node; and
receive, from the network node, a communication without applying phase noise correction associated with the communication based at least in part on the phase noise power level and one or more conditions being satisfied.

2. The UE of claim 1, wherein, to cause the UE to receive the indication of the phase noise power level, the at least one processor is configured to cause the UE to receive the indication via a radio resource control communication or a medium access control (MAC) control element communication.

3. The UE of claim 1, wherein, to cause the UE to receive the indication of the phase noise power level, the at least one processor is configured to cause the UE to receive the indication via a physical layer communication.

4. The UE of claim 1, wherein the phase noise power level associated with the network node is an integrated phase noise power level associated with the network node.

5. The UE of claim 1, wherein the at least one processor is further configured to cause the UE to:
estimate a channel thermal noise level, and
wherein the one or more conditions include a condition associated with a difference between the channel thermal noise level and the phase noise power level satisfying a threshold.

6. The UE of claim 5, wherein, to cause the UE to estimate the channel thermal noise level, the at least one processor is configured to cause the UE to:
measure a channel noise level associated with a channel via which the communication is received; and
obtain the channel thermal noise level based at least in part on a difference between the channel noise level and the phase noise power level.

7. The UE of claim 5, wherein, to cause the UE to estimate the channel thermal noise level, the at least one processor is configured to cause the UE to:
measure the channel thermal noise level via radio resources associated with a downlink reference signal that are not allocated for data transmissions.

8. The UE of claim 1, wherein the at least one processor is further configured to cause the UE to:
measure an error vector magnitude (EVM) value associated with a channel via which the communication is received,
wherein the one or more conditions include a condition associated with the EVM value satisfying a threshold.

9. The UE of claim 8, wherein the threshold is based at least in part on a modulation and coding scheme associated with the communication.

10. The UE of claim 1, wherein the at least one processor is further configured to cause the UE to:
estimate a total noise level associated with a channel via which the communication is received,
wherein the one or more conditions include a condition associated with the total noise level satisfying a threshold.

11. A network node for wireless communication, comprising:
at least one memory; and
at least one processor communicatively coupled with the at least one memory, the at least one processor configured to cause the network node to:
obtain a phase noise power level associated with the network node; and
transmit an indication, for a user equipment (UE), of the phase noise power level associated with the network node.

12. The network node of claim 11, wherein, to cause the network node to transmit the indication of the phase noise power level, the at least one processor is configured to cause the network node to transmit the indication via a radio resource control communication or a medium access control (MAC) control element communication.

13. The network node of claim 11, wherein, to cause the network node to transmit the indication of the phase noise power level, the at least one processor is configured to cause the network node to transmit the indication via a physical layer communication.

14. The network node of claim 11, wherein the phase noise power level associated with the network node is an integrated phase noise power level associated with the network node.

15. The network node of claim 11, wherein, to cause the network node to obtain the phase noise power level, the at least one processor is configured to cause the network node to obtain the phase noise power level from a memory associated with the network node.

16. A method of wireless communication performed by a user equipment (UE), comprising:
receiving, from a network node, an indication of a phase noise power level associated with the network node; and
receiving, from the network node, a communication without applying phase noise correction associated with the communication based at least in part on the phase noise power level and one or more conditions being satisfied.

17. The method of claim 16, wherein receiving the indication of the phase noise power level comprises receiving the indication via a radio resource control communication or a medium access control (MAC) control element communication.

18. The method of claim 16, wherein receiving the indication of the phase noise power level comprises receiving the indication via a physical layer communication.

19. The method of claim 16, wherein the phase noise power level associated with the network node is an integrated phase noise power level associated with the network node.

20. The method of claim 16, further comprising:
estimating a channel thermal noise level, and
wherein the one or more conditions include a condition associated with a difference between the channel thermal noise level and the phase noise power level satisfying a threshold.

21. The method of claim 20, wherein estimating the channel thermal noise level comprises:
measuring a channel noise level associated with a channel via which the communication is received; and
obtaining the channel thermal noise level based at least in part on a difference between the channel noise level and the phase noise power level.

22. The method of claim 20, wherein estimating the channel thermal noise level comprises:
measuring the channel thermal noise level via radio resources associated with a downlink reference signal that are not allocated for data transmissions.

23. The method of claim 16, further comprising:
measuring an error vector magnitude (EVM) value associated with a channel via which the communication is received,
wherein the one or more conditions include a condition associated with the EVM value satisfying a threshold.

24. The method of claim 16, further comprising:
estimating a total noise level associated with a channel via which the communication is received,
wherein the one or more conditions include a condition associated with the total noise level satisfying a threshold.

25. The method of claim 24, wherein the threshold is based at least in part on a modulation and coding scheme associated with the communication.

26. A method of wireless communication performed by a network node, comprising:
obtaining a phase noise power level associated with the network node; and
transmitting an indication, for a user equipment (UE), of the phase noise power level associated with the network node.

27. The method of claim 26, wherein the indication of the phase noise power level enables a phase noise correction operation to be skipped for a channel associated with the UE.

28. The method of claim 26, wherein transmitting the indication of the phase noise power level comprises transmitting the indication via a radio resource control communication or a medium access control (MAC) control element communication.

29. The method of claim 26, wherein the phase noise power level associated with the network node is an integrated phase noise power level associated with the network node.

30. The method of claim 26, wherein obtaining the phase noise power level comprises obtaining the phase noise power level from a memory associated with the network node.
